(19) United States
(12) Patent Application Publication
(10) Pub. No.: US 2003/0013441 A1
(43) Pub. Date: Jan. 16, 2003

(54) Tracking dropped communications

(75) Inventors: Kulvir S. Bhogal, Fort Worth, TX (US); Nizam Ishmael JR., Austin, TX (US); Javid Jameossanaie, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY (US)

(21) Appl. No.: 09/903,722

(22) Filed: Jul. 12, 2001

(51) Int. Cl. H04Q 7/20

(52) U.S. Cl. 455/423; 455/67.1; 455/572; 455/115

(57) ABSTRACT

The invention provides a method for tracking dropped communications. The method includes determining whether a call is dropped, determining dropped call characteristics if the call is dropped and logging the dropped call characteristics.

### TECHNICAL FIELD OF THE INVENTION

The present invention relates generally to communications devices, and more particularly to a method for tracking dropped communications usage time.

### BACKGROUND OF THE INVENTION

It is well known that users of wireless communication devices, such as mobile phones, experience inconsistencies in connection quality. These inconsistencies can result in calls or connections being interrupted or dropped. Depending on the communication company service quality and location of the caller, sudden interruptions of service, or dropped calls, can be frequent. Mobile phone companies recognize that the service they provide is still in a fledgling state and interruptions of service and dropped calls will occur with the current technology and infrastructure. As a consequence, many of these companies have decided to credit customers for calls that are dropped by crediting customers courtesy minutes, or the like or reimbursements for costs incurred because of the frequency of call dropping, and for other similar reasons.

The process by which a customer obtains reimbursement, however, can be very tedious and cumbersome. Currently, the customer may have to wait until a bill is received. The customer must then review the bill and contact a customer service representative to report each instance of a call that was dropped. Obviously, customers might not remember all calls that may have been dropped and as a consequence might report calls as being dropped which were not dropped or might forget to report calls which were dropped.

Some companies are offering customers a service number to report a call being dropped. This method of reimbursement takes a significant amount of time to perform as well. Since the process is time-consuming customers become discouraged from using it.

In light of the above disadvantages, it would be desirable to provide a method to conveniently obtain credit or reimbursements for dropped calls or interruptions in wireless communication services.

### SUMMARY OF THE INVENTION

One aspect of the invention provides a method of tracking dropped calls including determining whether a call is dropped, determining dropped call characteristics if the call is dropped and logging the dropped call characteristics.

Another aspect of the invention includes marking the dropped call, wherein a call drop function is activated. Activating the call drop function may include selecting a menu feature. Activating the call drop function may include depressing a call drop button. Determining the dropped call characteristics may include counting time increments in response to a call and determining a call count based on time increments. A plurality of call counts may be combined or added to determine an accumulated call count. The dropped call characteristics may include a call location. The dropped call characteristics may include battery charge strength information. The dropped call characteristics may include a call drop origin. The dropped call characteristics may include a call time and a call date. Logging the dropped call characteristics may include storing the dropped call characteristics in a memory database. The dropped call characteristics may be transmitted to a provider.

Another aspect of the invention provides a computer usable medium including a program for tracking dropped calls including computer readable program code for determining whether a call is dropped, computer readable program code for determining dropped call characteristics if the call is dropped and computer readable program code for logging the dropped call characteristics.

Other aspects of the present invention may include a computer usable medium including a program for marking the dropped call, wherein a call drop function is activated. Activating the call drop function may include selecting a menu feature. Activating the call drop function may include depressing a call drop button. Determining the dropped call characteristics may include a computer usable medium including a program for counting time increments in response to a call and determining a call count based on time increments. A plurality of call counts may be combined or added to determine an accumulated call count. The dropped call characteristics may include one or more of a call location, battery charge strength information, a call drop origin, a call time and a call date. Logging the dropped call characteristics may include a computer usable medium including a program for storing the dropped call characteristics in a memory database. The dropped call characteristics may be transmitted to a provider.

Another aspect of the invention provides a dropped call tracking system including a means for determining whether a call is dropped, a means for determining dropped call characteristics if the call is dropped and a means for logging the dropped call characteristics.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic overview of one embodiment of the present invention;

FIG. 2 is a flowchart of one embodiment of the present invention;

FIG. 3 is a schematic diagram of a process according to another embodiment of the present invention; and

FIG. 4 is a schematic diagram of a portion of the process in FIG. 3.

### DETAILED DESCRIPTION OF THE PRESENTLY PREFERRED EMBODIMENTS

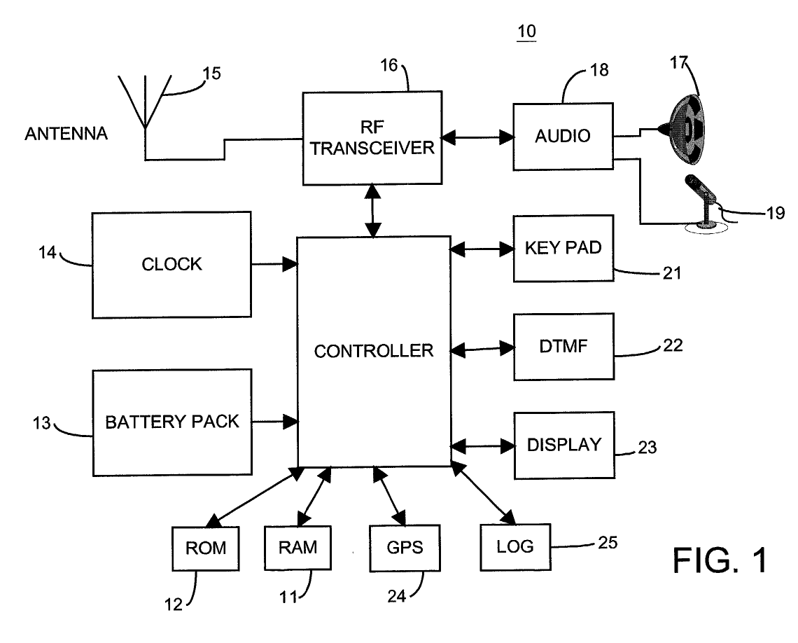

Referring to FIG. 1, one embodiment of the present invention is shown in the aggregate as a cellular telephone unit 10. The phone unit 10 may support a controller 20 that coordinates the functions of the unit. The controller 20 may have an associated memory comprising an EPROM chip 12 that stores the firmware that forms the code operating code of the unit 10. At least one RAM chip 11 may be electrically connected to the controller 20. The RAM chips 11 may provide programmable memory that may include command codes and data storage for logging call data including call drop information. The call drop information itself can be stored in a log or an area of memory 25 on the unit 10 associated with the controller 20 in a known fashion. A clock chip 14 may be associated with the controller 20 to provide date and timer functions for the phone unit 10. The date and timer functions may comprise data for call logging purposes. A positioning device 24 (GPS, or the like) may be associated with the controller to provide location information for the unit 10.

An antenna 15 provides a means for the phone unit 10 to communicate with a cellular phone provider. The antenna 15 may be electrically connected to an RF transceiver 16 associated with the controller 20. The RF transceiver 16 may be connected with an analog audio circuit 18 and associated earphone 17 output and microphone 19 input. The audio circuit 18 may be connected to the controller 20 and may provide audio output of touch-tones, warning signals, and the like. The unit 10 may include a DTMF decoder chip 22 and a keypad 21 for a variety of functions. The functions may comprise menu navigation, entry of data and telephone numbers, and general operation of the unit 10 by an operator. Furthermore, the unit 10 may comprise a LCD or LED display 23 for communicating phone numbers, account data, navigation menus, and the like with the unit 10 operator. A battery 13 connected to the controller 20 may power the unit 10. The unit 10 may include as part of the controller 20, a circuit or device to sense, track or otherwise determine the battery status for the unit.

The controller 20 may comprise an algorithm or method written in computer readable program code run by a microprocessor. Those skilled in the art will recognize that the controller 20 may function as part of a cellular or mobile telephone unit, a PDA device, or other telecommunications device. For the purposes of describing the operation of an embodiment, the controller 20 comprises a microprocessor running at least one program in a cellular telephone unit 10.

During a typical wireless call, it is known in at least some instances that a connection takes up a wireless channel as well as a “public switched telephone network” (PTSN) channel, which is held open until the call is completed. Termination of the connection may occur when a hang up sequence is initiated by any one of the connected units. Other connections may include only the connection of a pair or more cellular units through a cellular service provider. Regardless of the number of entities involved in the connection, the hang-up sequence typically may include a hang-up message, request, or some amount of specific transmitted code that indicates to the service provider, and subsequently the connected units, that communication is to be discontinued.

Unintentional termination of the connection (a dropped call) can occur when one of the units or service provider no longer receives the carrier signal of one or more of the connected parties. Typically, a unit “times out” after a set period of time without detecting the signal and the connection is closed. Many cell phones can provide the user with a message indicating that a time out condition has been detected or the connection unintentionally discontinued.

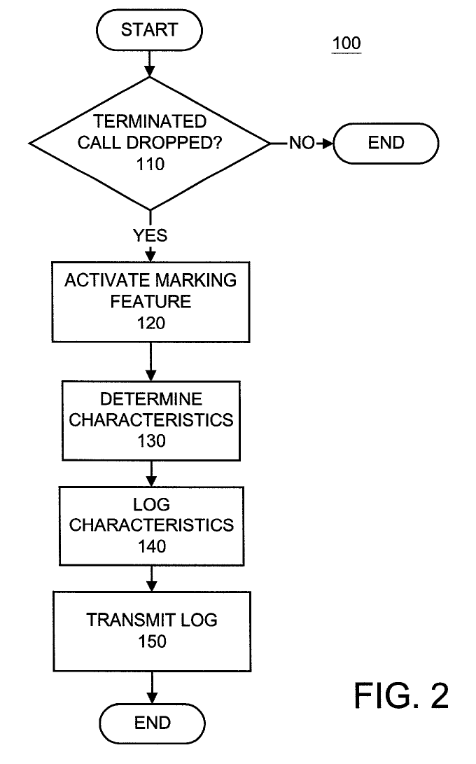

Referring to FIG. 2, one embodiment of a process to track dropped calls is illustrated generally at 100. As generally described above, when a call is terminated, it can occur intentionally or unintentionally. In the event the call is terminated unintentionally, a determination is made that the call is a dropped call (block 110). This can occur when the unit 10 detects a time out condition or stops receiving a signal for a predetermined time without receiving a hang up sequence or protocol. In the event that a call or communication is terminated intentionally, process 100 is immediately ended. This can occur when the unit 10 receives a hang up sequence, i.e., a specific code or message that indicates that the call has been terminated by one of the participating parties of the call. Thus, the unit 10 can power down and return to a standby mode as is conventional without taking further action.

The ability to detect a dropped call is a feature that is currently present in many cell phone or similar devices. Conventionally, the device will display a message to the effect that the call has been dropped to alert the user. However, at times, the unit 10 may not be provided with this feature, or for whatever reason cannot or does not detect a dropped call. In this instance, it may be necessary for the user of the unit 10 to make the determination that the call is a dropped call.

In the event that the determination is made that the terminated call is a dropped call a marking feature may be activated (block 120). In one embodiment of the invention, the marking feature generates a log entry related to the dropped call. In one embodiment of the invention, the marking feature may be included in the unit 10 as an automatic feature or function. In other words, the marking feature may be computer readable program code in communication with the controller 20, which marks the dropped call or, as will be explained more fully below, performs an automated append to a call log. The unit 10 upon the determination that the call is a dropped call may activate the automatic marking feature.

In another embodiment, the marking feature may be a key on keypad 21, or combination of keys or keystrokes or menu option that manually activates the marking feature. In the alternate, the user using voice commands or other control features of the unit may activate the marking feature. Essentially, as will be explained more fully below, the marking feature initiates the recording of data related to the call, which can be used by the user or service provider.

Upon activation of the marking feature a number of characteristics of the dropped call can be determined (block 130). One characteristic included in the log may be the location of the unit 10 at the time of the dropped call. The GPS unit 24 can provide this information. This information can be compiled and used by the cell phone service company for use in determining if equipment upgrades need to be made to an area (e.g., more cellular towers) of frequent dropped calls.

Another characteristic that may be included in the log may be the charge strength of the cell phone battery at the time of the dropped call. In the event that the battery was in an uncharged condition when the call is dropped it can be determined that the cell phone service provider was not at fault. In this case, the user may not be credited or reimbursed for the dropped call.

Another characteristic that may be included in the log may be an identification of the unit that caused the call to be dropped. In other words, if the communication is occurring between two cell phones its may have been the other caller's cell phone which caused the interruption of service.

Another characteristic that may be included in the log may be the time of the call provided by clock 14. The date of the call can be included in the call log. This information might be important in determining whether the customer is to be reimbursed with either off-peak or peak minutes.

These and other characteristics of the dropped communication may be logged into and stored in a local database existing in the memory of the unit 10 (block 140). The log can be transmitted to the cell phone service provider at predetermined intervals, or when the phone or device 10 is not in use. The log can be evaluated and appropriate reimbursement made by the cell phone service provider.

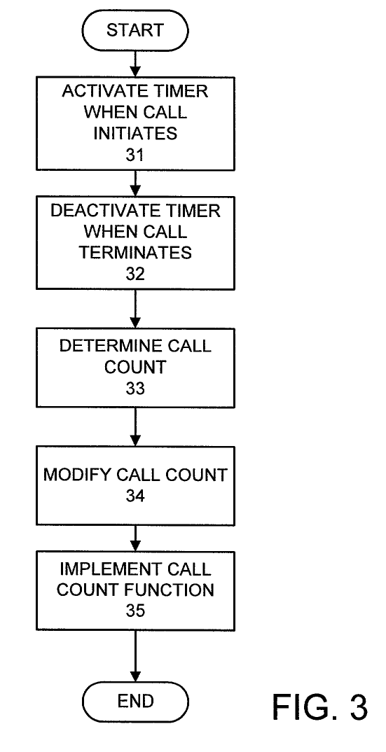

Referring to FIG. 3 one embodiment of the present invention is shown wherein the controller 20 may execute a program. During execution of the program, a timer may be activated when a call is initiated (block 31). The call may be any open communication between the unit 10 and a second party. The call initiation may comprise placing a call from the unit 10, receiving a call, or starting a transmission of information between the unit 10 and second party. After the call is initiated, the timer may be activated to count time increments of the call. The time increments may comprise seconds, minutes, or any other suitable division of time. The timer may comprise the clock chip 14 and communicate the date and timer data to the controller 20. The timer may continue to count time increments until the call is terminated (block 32). A call count may be determined (block 33) based on the time increments of the call. In one embodiment, the call count may comprise total call time duration in minutes and seconds.

The call count may then be modified (block 34) based on calling plan parameters. The calling plan parameters may be based on a variety of factors reflecting calling plans offered by cellular phone plan providers. Modifying the call count may comprise rounding the call count to the nearest minute. Providers typically bill cell phone calls up to the next whole minute. For example, a four-minute-five-second call would be billed as a five-minute call. In one embodiment, the call count may be rounded up to a nearest whole minute for each call.

Modifying the call count may comprise subtracting an initial open connection time from the call count. Calling plans may provide a discount for periods within a call (e.g., first incoming minute free). In one embodiment, the modified call count may be calculated by discounting a first minute from the call count by simply subtracting one minute from the determined call count.

Modifying the call count may comprise discounting an incoming call. Calling plans may offer reduced billing for those calls made into the unit 10. The reduced billing is typically in the form of a predetermined discount. For example, an incoming call may be free. In one embodiment, incoming calls may be discounted for an incoming call thereby diminishing the call count proportional to the predetermined discount. The call may be fully discounted so that the call count would be reset to zero.

Modifying the call count may comprise discounting a nighttime or weekend call. As with the incoming call, calling plans may offer reduced billing for calls occurring during nighttime and/or weekends. Providers typically determine cutoff times that boundary nighttime hours and weekend days. The cutoff times may be transmitted to the unit 10 by the provider or entered into the unit via the keypad. In one embodiment, the call count may be discounted for a nighttime call and weekend call thereby diminishing the call count proportional to the predetermined discount.

The aforementioned modifications to the call count may provide more accurate estimates of usage time because the modifications are based on the calling plan parameters. Those skilled in the art will recognize that providers may offer other calling plan parameters such as discounted holiday calling, or the like, that may be used to modify the call count to achieve a more accurate usage time estimate.

After the call count has been modified (block 34), a call count function may be executed (block 35). The call count function may include a number of functions that provides additional features to the unit 10 operator. The functions may be executed as desired by the operator and may be controlled through keypad 21 operation.

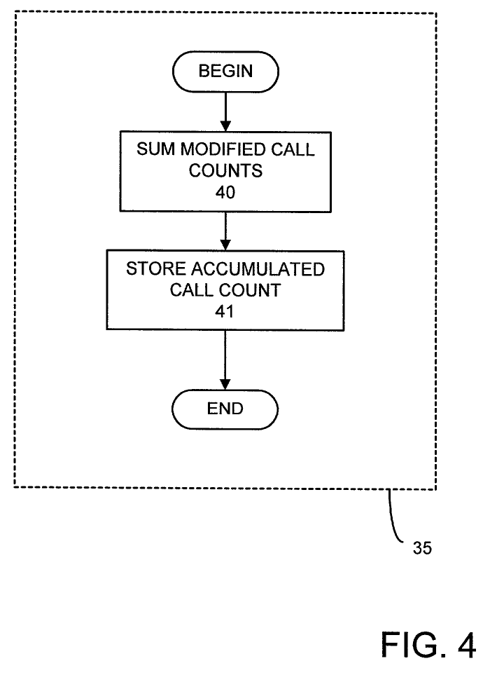

A detailed view of one call count function is shown in FIG. 4. The call count function may allow the modified call count from each call to be summed (block 40) to determine an accumulated call count. The accumulated call count may then be stored in the memory of the unit (block 41). The operator may then access the accumulated call count data from the unit memory as desired. In one embodiment, the accumulated call count may be accessed through a keypad 21 operation and conveyed to the operator via the display 23. The accumulated call count may also be reset through a keypad 21 operation as needed, as with the beginning of a billing cycle. Therefore, the accumulated call count may provide the operator with an accurate estimate of total usage time for a given time period. In one embodiment, the phone can automatically reset the accumulated call count when the billing cycle date/time is reached.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. Method of tracking dropped calls comprising:
determining whether a call is dropped;
determining dropped call characteristics if the call is dropped; and
logging the dropped call characteristics.

2. The method of claim 1 further comprising marking the dropped call, wherein a call drop function is activated.

3. The method of claim 2 wherein activating the call drop function comprises selecting a menu feature.

4. The method of claim 2 wherein activating the call drop function comprises depressing a call drop button.

5. The method of claim 1 wherein determining the dropped call characteristics comprise:
counting time increments in response to a call; and
determining a call count based on time increments.

6. The method of claim 5 further comprising adding a plurality of call counts to determine an accumulated call count.

7. The method of claim 1 wherein the dropped call characteristics comprise a call location.

8. The method of claim 1 wherein the dropped call characteristics comprise a battery charge strength indication.

9. The method of claim 1 wherein the dropped call characteristics comprise a call drop origin.

10. The method of claim 1 wherein the dropped call characteristics comprise a call time and a call date.

11. The method of claim 1 wherein logging the dropped call characteristics comprises storing the dropped call characteristics in a memory database.

12. The method of claim 1 further comprising transmitting the dropped call characteristics to a provider.

13. A computer usable medium including a program for tracking dropped calls comprising:
computer readable program code for determining whether a call is dropped;
computer readable program code for determining dropped call characteristics if the call is dropped; and
computer readable program code for logging the dropped call characteristics.

14. The computer usable medium of claim 13 further comprising marking the dropped call, wherein a call drop function is activated.

15. The computer usable medium of claim 14 wherein activating the call drop function comprises selecting a menu feature.

16. The computer usable medium of claim 14 wherein activating the call drop function comprises depressing a call drop button.

17. The computer usable medium of claim 13 wherein determining the dropped call characteristics comprise:
counting time increments in response to a call; and
determining a call count based on time increments.

18. The computer usable medium of claim 17 further comprising adding a plurality of call counts to determine an accumulated call count.

19. The computer usable medium of claim 13 wherein the dropped call characteristics comprise a call location.

20. The computer usable medium of claim 13 wherein the dropped call characteristics comprise a battery charge strength indication.

21. The computer usable medium of claim 13 wherein the dropped call characteristics comprise a call drop origin.

22. The computer usable medium of claim 13 wherein the dropped call characteristics comprise a call time and a call date.

23. The computer usable medium of claim 13 wherein logging the dropped call characteristics comprises storing the dropped call characteristics in a memory database.

24. The computer usable medium of claim 13 further comprising transmitting the dropped call characteristics to a provider.

25. A dropped call tracking system comprising:
means for determining whether a call is dropped;
means for determining dropped call characteristics if the call is dropped; and
means for logging the dropped call characteristics.
